(19) United States
(12) Patent Application Publication
(10) Pub. No.: US 2006/0277443 A1
(43) Pub. Date: Dec. 7, 2006

(54) Method and system for acquiring definitions of debug code of a basic input/output system

(75) Inventors: Yong-Xing You, Shenzhen (CN); Feng-Long He, Shenzhen (CN); Xiang Cao, Shenzhen (CN)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: HON HAI Precision Industry CO., LTD., Tu-Cheng City (TW)

(21) Appl. No.: 11/411,161

(22) Filed: Apr. 25, 2006

(30) Foreign Application Priority Data
Jun. 3, 2005 (CN) 200510035135.2

(51) Int. Cl. G06F 11/00

(52) U.S. Cl. 714/38

(57) ABSTRACT

A method for displaying debug codes of a BIOS includes the steps of: initializing a host electronic system and sending out a debug code corresponding to the initialization of the host electronic system to a debug card; displaying the debug code on an LED-display screen of the debug card; transmitting the debug code displayed on the LED-display screen to an application software; choosing the BIOS file corresponding to the debug code displayed, then acquiring and displaying the information via the application software. A system implementing this method includes a host electronic system with a BIOS for sending out a debug code during the initialization; a debug card connected electrically to the host electronic system for receiving and displaying the debug code sent out by the host electronic system; an application software for acquiring and displaying the information corresponding the debug code displayed on the debug card.

### BACKGROUND OF THE INVENTION

1. Field of the Invention

The invention relates to a method and a system for looking up debug codes of a Basic Input/Output System (BIOS), more particularly to a method and a system cooperating with a host electronic system and capable of acquiring and displaying the debug codes information for a BIOS.

2. General Background

Most contemporary electronic system, such as motherboards, interface cards, etc., are provided with BIOSs for power-on self tests (POST) and access of default set-up data upon initialization.

Due to the trend of computers toward multitasking operations, the operations associated with BIOS have grown in complexity. In the development stages of a computer system, even before an operating system is loaded, different factors, such as failure of some components, errors in BIOS codes, etc., may result in boot-up failure and hinder development progress.

At this moment, due to the size limitation of BIOS codes, and because debug application software can not be executed since the operating system has not yet been loaded, the cause of failure can only be exhaustively sought with the aid of hardware-error detecting equipment. Therefore, as a solution to these problems, it has been proposed heretofore that when a certain stage of operation has proceeded through the control of the BIOS codes, a debug code corresponding to the operating stage should be sent out. In this way, a system developer can provide a peripheral device to be coupled to the system-under-test for debugging in order to intercept and display the debug codes in real time.

A debug code received by the peripheral device is shown as long as a succeeding debug code has not yet been received. Hence, if a debug code is continuously shown by the peripheral device after a computer system is turned on and prior to loading of an operating system, a clue will be provided to the system developer as to the possible cause of system or peripheral failure so that appropriate steps can be taken to speed up the debugging procedure and thus the progress of system development. At present, this sort of simple debugging mechanism is widely used in the development of electronic systems, such as computers, motherboards, etc.

A conventional method as shown in FIG. 1 comprises: initializing a motherboard and executing a BIOS program (S11); a debug code being written to port 80 of the motherboard when the BIOS is testing a hardware on the motherboard (S12); a debug card reading the debug code from port 80 and displaying it on a light-emitting diode (LED) display screen (S13); the BIOS determining if the testing is successful or not (S14); if the testing is not successful, the debug code is continuously shown by the LED-display screen, it reveals that a component on the motherboard has not passed the testing, and the initialization of the motherboard has to be stopped. At this time, people must manually compare the debug code displayed on the LED-display screen with code table issued by BIOS manufacturers such as AMI, AWARD, PHOENIX and so on, and then acquire the debug code information (S15), and take action as required. If the testing is successful, the BIOS determines if the testing is finished or not (S16), if the testing is not finished it returns to step S12, if the testing is complete the process ends. Because people must search the debug code in the code table and find out the information corresponding to the debug code by manual operation, the conventional method is cumbersome and time-consuming; in addition, there is possibility of human error when looking up the codes.

What is needed is a method and a system for precisely and conveniently acquiring and displaying the information about the debug codes of a BIOS.

### SUMMARY

A method in accordance with a preferred embodiment of the present invention includes the steps of: initializing a host electronic system and sending out a debug code corresponding to the initialization of the host electronic system to a debug card; displaying the debug code on an LED-display screen of the debug card; transmitting the debug code displayed on the LED-display screen to an application software; and choosing the BIOS file corresponding to the debug code displayed, then acquiring and displaying the information via the application software.

A system in accordance with a preferred embodiment of the present invention includes: a host electronic system with a BIOS for sending out a debug code during the initialization; a debug card connected electrically to the host electronic system for receiving and displaying the debug code sent out by the host electronic system; and an application software for acquiring and displaying the debug code information correspond to the debug code displayed on the debug card.

Other advantages and novel features will become more apparent from the following detailed description when taken in conjunction with the accompanying drawing, in which:

### BRIEF DESCRIPTION OF THE DRAWINGS

FIG. 1 is a flowchart of a conventional method of acquiring information on a debug code of a BIOS;

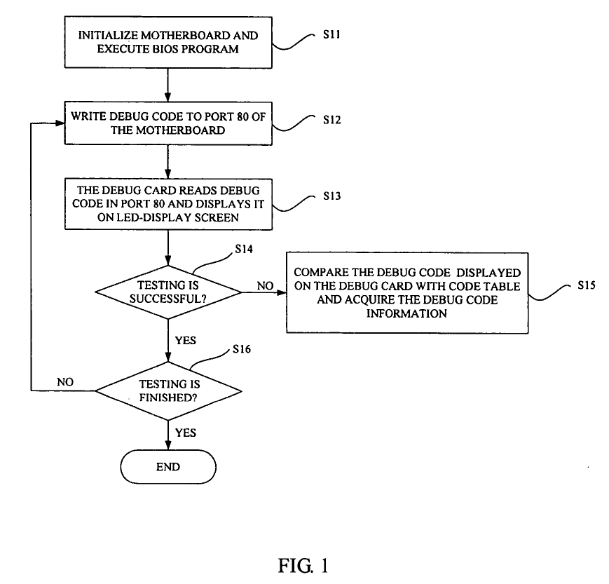

FIG. 2 is a flowchart of a method of acquiring information on debug codes of a BIOS in accordance with a preferred embodiment of the present invention; and

FIG. 3 is a flowchart of a method of acquiring information on debug codes of a BIOS in accordance with another preferred embodiment of the present invention.

### DETAILED DESCRIPTION OF THE EMBODIMENTS

A system of looking up debug codes of a BIOS is adapted for use in a host electronic system, such as a motherboard, an interface card, etc. In the following description, the host electronic system is a computer motherboard for illustrative purposes. The system is used to look up debug codes of a BIOS that are output by the host electronic system in sequence during initialization of the host electronic system.

The system includes a motherboard, a debug card, a computer system, and an application software which runs on the computer system. The debug card is connected electrically to the motherboard so as to receive the debug codes sequentially from the motherboard. In practice, the debug card has an LED-display screen to display the received debug codes. During the initialization of the motherboard, each program is associated with a corresponding debug code. When the motherboard is initialized, the BIOS in the motherboard is loaded to execute operation of power-on self tests (POST) and access default set-up data, etc. Before each operation is executed, the BIOS sends out the associated debug code to the debug card. When a debug code is continually shown by the LED-display screen and not changed after the motherboard is turned on and prior to loading of an operating system, something is wrong in the initialization of the motherboard. Then the debug code continually shown is transmitted to the application software. An initializing interface window of the application software includes a code-input frame and an information-display frame. The debug code is transmitted from the debug card into the code-input frame of the initializing interface window. In practice, if the debug card has COM ports, the COM ports of the debug card are connected to the COM port of the computer running the application software via a COM cable. In this way, the debug code is transmitted from the COM port of the debug card to the COM port of the computer via the COM cable, and then the application software reads the debug code and inputs it into the code-input frame of the initializing interface window. If the debug card has no COM port, the debug code is manually input into the code-input frame of the application software. Next, the BIOS file corresponding to the debug code in the code-input frame of the application software is chosen, the detailed information about the debug code is displayed in the information-display frame of the initializing interface window. For example, if the debug code displayed in the code-input frame is “00”, the information “the motherboard has not tested normally” is displayed in the information-display frame.

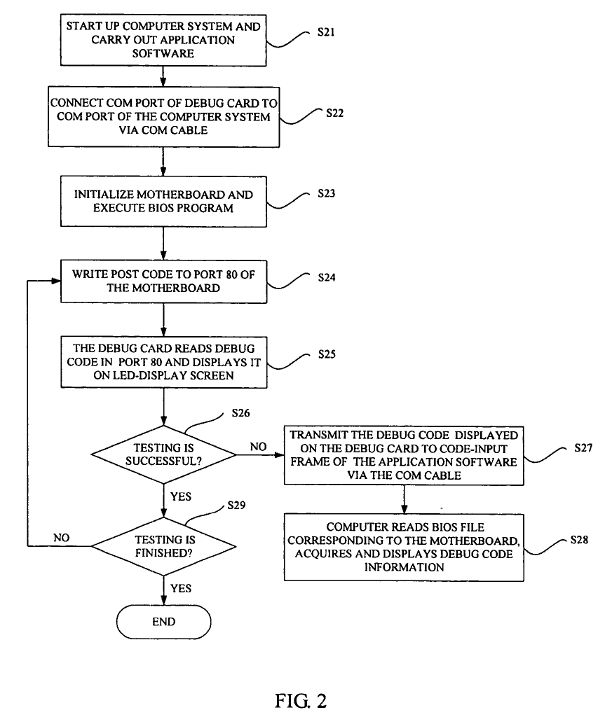

For a more detailed description of the operating relationship among the aforesaid components, reference is made to FIG. 2, which shows a flowchart to illustrate operation of the system in accordance with a preferred embodiment of the present invention.

At step 21, start up the computer system and initialize the application software, thus the application software is running in the computer system.

At step 22, connect a COM port of the debug card to a COM port of the computer system via a COM cable.

At step 23, initialize the motherboard and execute the BIOS programs which are on the motherboard, and the debug card is connected electrically to the motherboard.

At step 24, the BIOS writes a debug code to port 80 of the motherboard.

At step 25, the debug card reads the debug code in the port 80 and displays it on the LED-display screen of the debug card.

At step 26, the BIOS determines if the testing is successful or not.

At step 27, if the testing is not successful, then the motherboard has not been initialized normally, and the debug code is continuously shown on the LED-display screen, the debug code displayed on the LED-display screen is transmitted to the code-input frame of the initializing interface window via the COM cable.

At step 28, a BIOS file corresponding to the motherboard is read, and then the information for the corresponding debug code is acquired and displayed.

At step 29, the BIOS determines if all testing is finished, if all testing is not finished, it returns to step S24 to continue the testing, if testing is finished then the process ends.

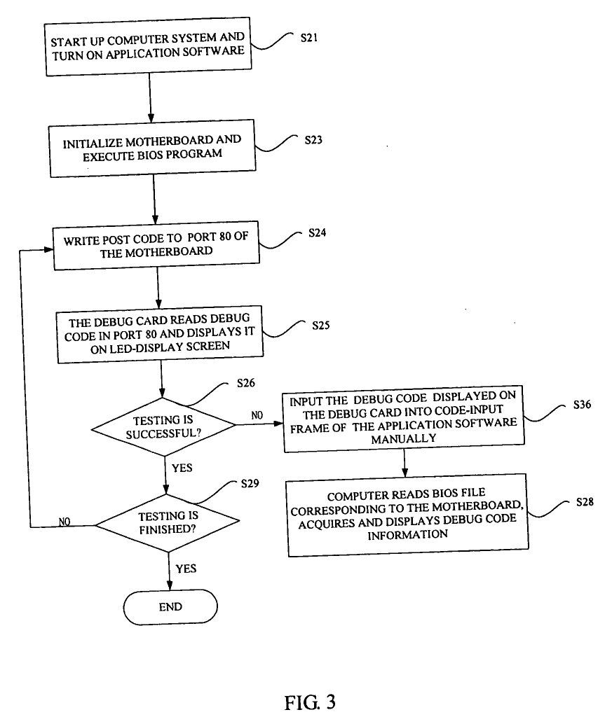

Refer to FIG. 3, which shows a flowchart to illustrate operation of the system in accordance with another preferred embodiment of the present invention. The system is similar to FIG. 2 but step S22 is omitted and step S36 is done manually.

It is believed that the present embodiment and its advantages will be understood from the foregoing description, and it will be apparent that various changes may be made thereto without departing from the spirit and scope of the invention or sacrificing all of its material advantages, the example hereinbefore described merely being a preferred or exemplary embodiment.

We claim:

1. A method for looking up debug codes of a BIOS, comprising:
displaying a debug code on a debug card during the initializing of a motherboard;
transmitting the debug code displayed on the debug card to an application software; and
choosing a BIOS file corresponding to the motherboard then acquiring and displaying information of the debug code.

2. The method as claimed in claim 1, wherein the debug code is corresponding to an initialization of the motherboard.

3. The method as claimed in claim 1, wherein the debug card includes an LED-display screen, the debug code is displayed on the LED-display screen.

4. The method as claimed in claim 1, wherein an initializing interface window of the application software includes a code-input frame for receiving the debug code transmitted by the debug card.

5. The method as claimed in claim 4, wherein the debug code is transmitted to the code-input frame by a COM cable which connects a COM port of the debug card and a COM port of a computer running the application software.

6. The method as claimed in claim 4, wherein the debug code is input into the code-input frame manually.

7. The method as claimed in claim 4, wherein the initializing interface window includes an information-display frame for displaying the debug code information.

8. A system for displaying debug codes of a BIOS, comprising:
a motherboard with a BIOS for sending out a debug code during initialization of the motherboard;
a debug card connected electrically to the motherboard for receiving and displaying the debug code sent out by the motherboard; and
an application software for acquiring and displaying information of the debug code displayed on the debug card.

9. The system as claimed in claim 8, wherein the debug code is corresponding to the initialization of the motherboard.

10. The system as claimed in claim 8, wherein the debug card has an LED-display screen, the debug code is displayed on the LED-display screen.

11. The system as claimed in claim 8, wherein an initializing interface window of the application software includes a code-input frame for receiving the debug code transmitted by the debug card.

12. The system as claimed in claim 11, wherein the debug card is transmitted to the code-input frame by a COM cable which connects a COM port of the debug card and a COM port of a computer running the application software.

13. The system as claimed in claim 11, wherein the debug code is input into the code-input frame manually.

14. The system as claimed in claim 11, wherein the initializing interface window includes an information-display frame for displaying the information acquired by the application software.

15. A method for acquiring testing information from an electronic system, the method comprising the steps of:
initializing an electronic system to be tested which comprises more than one testable electronic components therein;
executing power-on self tests (POST) on said electronic system for said more than one testable electronic components of said electronic system;
retrieving debug codes related to testing results of said POST from said electronic system; and
translating a selective one of said debug codes automatically in order to acquire recognizable testing information corresponding to said selective one of said debug codes.

16. The method as claimed in claim 15, further comparing the step of displaying a portion of said debug codes on a debug card installable in said electronic system.

17. The method as claimed in claim 15, wherein said debug codes are retrievable through a COM cable out of said electronic system.
